(19) United States
(12) Patent Application Publication
(10) Pub. No.: US 2016/0378707 A1
(43) Pub. Date: Dec. 29, 2016

(54) Vehicular intra network apparatus and client-host method of operation

(71) Applicants: Shivinder Singh SIKAND, Santa Cruz, CA (US); Dean Drako, Austin, TX (US)

(72) Inventors: Shivinder Singh SIKAND, Santa Cruz, CA (US); Dean Drako, Austin, TX (US)

(21) Appl. No.: 14/808,864

(22) Filed: Jul. 24, 2015

Related U.S. Application Data
(60) Provisional application No. 62/185,796, filed on Jun. 29, 2015.

(51) Int. Cl. G06F 13/42; G06F 21/60; H04L 29/08

(52) U.S. Cl. CPC G06F 13/4282; H04L 67/12; G06F 21/602

(57) ABSTRACT

A networking apparatus couples a plurality of vehicle nodes to improve bandwidth, security, and subsystem independence. The networking apparatus couples a plurality of thin client units to a single virtualized master control unit container host. Each thin client unit transforms CAN protocol messages to encrypted packets for a real time Ethernet interconnect. Vehicle subsystem modules connect via a personalized thin client unit which will filter, correct, and authenticate messages at the periphery of the networking apparatus. Between thin client units, the host encrypts and decrypts a message, directs the message to the proper recipient, authenticates each message, and centrally provides the functionality of a plurality of electronic control units. The virtualized master control unit container host may be updated over the air and perform installation and validation checks of a new version of one or more electronic control unit images while the vehicle is in operation using a previous version.

### CROSS-REFERENCES TO RELATED APPLICATIONS

This non-provisional application benefits from Ser. No. 62/185,796 filed 29 Jun. 2015 which is incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Technical Field

Vehicle control and network security.

Description of the Related Art

In a conventional Controller Area Network (CAN) each node on the bus must listen to every transmission to establish priority and thus is vulnerable to attack and denial of service. What is needed is a more robust and secure network apparatus to couple legacy and next generation vehicle subsystems.

This includes Security for doorlocks, Addressing inherent hackability of CANbus, enabling quicker time to market, less proprietary data, more open Domain Controllers, Higher bandwidth for sensors e.g. RADAR, safely mixing propulsion and non-propulsion packet traffic, all resulting in Provable Functional Safety/Automotive Safety Integrity Level.

### BRIEF SUMMARY OF THE INVENTION

A networking apparatus couples a plurality of vehicle nodes to improve bandwidth, security, and subsystem independence.

The networking apparatus couples a plurality of thin client units to a single virtualized master control unit container host.

Each thin client unit transforms CAN protocol messages to encrypted packets for a real time Ethernet interconnect.

Vehicle subsystem modules connect via a personalized thin client unit which filters, corrects, and authenticates messages at the periphery of the networking apparatus.

Between thin client units, the host encrypts and decrypts a message, directs the message to the proper recipient, authenticates each message, and centrally provides the functionality of a plurality of electronic control units.

The virtualized master control unit container host may be updated over the air and perform installation and validation checks of a new version of one or more electronic control unit images while the vehicle is in operation using a previous version.

Intrusion messages from malicious thin client units may be detected and suppressed.

A vehicle subsystem can be independently improved without interfering with the operation of other subsystems.

Noisy or defective data emitted by a sensor is filtered, corrected, or discarded by a thin client unit personalized to the appropriate functionality of the node.

A real time Ethernet backbone couples a plurality of local client hubs to a single vehicle control unit. Each client hub only has an encryption/decryption engine, and a PHY modem coupled to a layer 2 Ethernet interface. The vehicle control unit creates a trust zone for each app and manages traffic across the backbone. Non-trivial computing is performed by a central containerized platform. This includes diagnostics for failures as well as malicious intrusion detection.

A single vehicle control unit transforms operator control indicia into a plurality of individual commands, and securely transmits said commands to actuators and control devices.

An operating system provides an encrypted application programming interface to operate functions such as torque vectoring, cooling, braking, and battery management.

The OS provides an isolating trust zone to each layer or application for authentication and validation.

Upgrades are available to install new features or improvements after a vehicle is in the field.

Independent developers may test and furnish new capabilities without exposing or corrupting the IP of other vehicle modalities.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 and FIG. 2 are system block diagrams of network apparatuses of the subject matter;

FIG. 3-4 is a data flow diagram of components in a secure network; and

FIG. 5-6 is a block diagram of software components shown as a rotated stack.

### DETAILED DISCLOSURE OF EMBODIMENTS OF THE INVENTION

A vehicular intra network (ViNet) interposes a virtual CAN bus between conventional functional modules such as brake subsystems, light subsystems etc. Sensors, actuators, and control devices which conventionally connect to a bus through a CAN node may be attached to a thin client unit instead. Or a conventional CAN node consisting of a CAN transceiver, CAN controller, and processor coupled to the sensors, actuator, and control devices can be attached to a local CAN bus provided by each thin client unit.

The thin client units are coupled to a virtualized master control unit container host by a real time Ethernet medium. If necessary, messages between thin client units are routed by one of the containers of the host. A virtual channel isolates each thin client unit from unnecessary traffic. The thin client unit encrypts a message to the host and the host authenticates each thin client unit. The host encrypts a message to each recipient thin client unit and the thin client authenticates the host. The host protects each thin client unit from attacks originated by another thin client unit. A virtual CAN bus (VCAN) is provided between any two CAN nodes by the host and two TCUs.

Each TCU has a personality and protects the VCAN from inappropriate or defective messages emitted by a CAN node. A defective or malicious sensor may only corrupt traffic on a local CAN bus which is isolated by its TCU from the virtual CAN bus. The TCU can detect and defend against an intrusion in its local CAN bus. The TCU also authenticates and decrypts messages received from the real time Ethernet to protect its served subsystem.

The TCU may rewrite poorly formatted frames to comply with standards or even translate from one format version to another format for flexible compatibility among generations of subsystems. The TCU may suppress functionality of a device attached to it according to its custom personality.

The TCU enables master control for subsystems to become centralized into containers within the host. Thus upgrades and corrections may be performed for any electronic control unit within a container of the host while another container remains online with the thin client units. This provides rapid cutover from one version to another and recovery.

The Virtual CAN architecture supports gradual migration from legacy CAN nodes which perform firmware functional to subsystems to CAN-free implementations which utilize the processor power of the containerized host. System integration is simplified because each subsystem enjoys its own virtual channel. Legacy CAN nodes will not even see messages emitted by or intended for other CAN nodes unless they are attached to the same TCU.

A malicious or malfunctioning CAN node is isolated by its personalized TCU from disrupting other CAN nodes, other TCUs, and the host attached to the Virtual CAN bus.

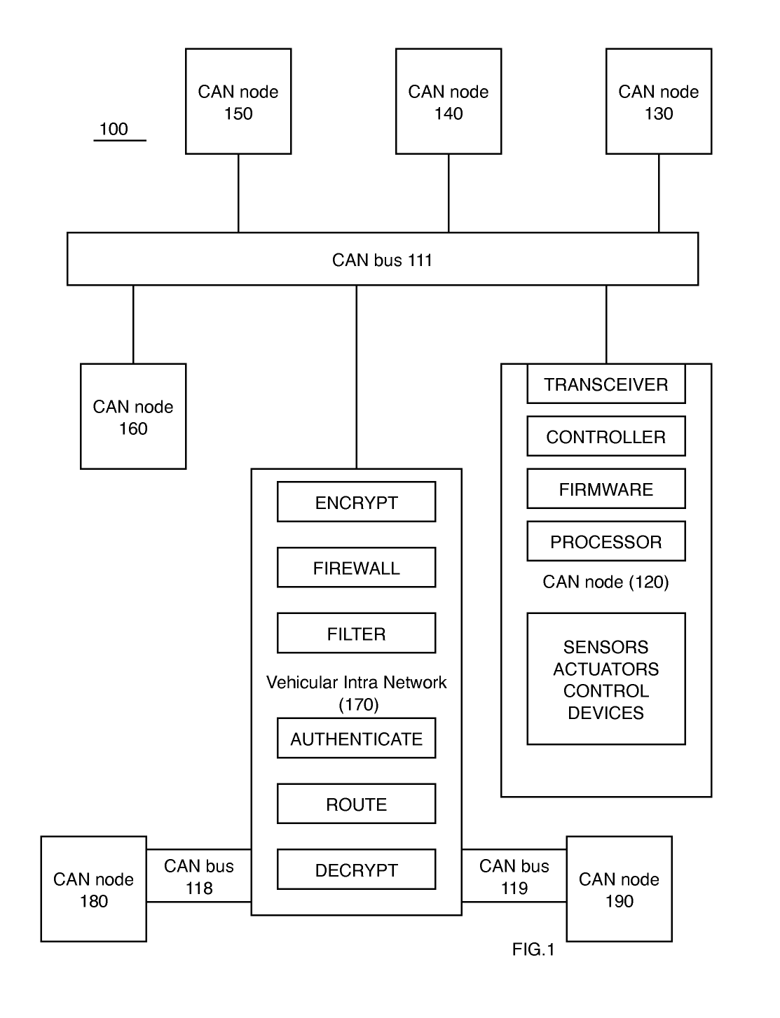

FIG. 1 illustrates a system 100 which includes a conventional Controller Area Network (CAN) protocol bus 111 which couples a plurality of CAN-nodes 120, 130, 140, 150, and 160. It can be appreciated that all these CAN nodes observe all traffic emitted by one another and contend for priority or dominance. The details a of a typical CAN node 120 show that it is made of a CAN transceiver, a CAN controller, a processor, and firmware to operate the controller and processor which are connected to a variety of devices such as sensors, actuators, and control devices which belong to a vehicle subsystem. The CAN bus is susceptible to hacking, congestion, and disruption from a malfunctioning CAN node.

System 100 also shows a vehicular Intra network 170 coupled to CAN bus 111. This network isolates traffic on CAN bus 119 and CAN bus 118 from everything on CAN bus 111 except that which concerns CAN node 190 and CAN node 180 respectively. The traffic on the vehicular Intra network is encrypted and cannot be easily spoofed or intercepted by merely attaching a probe as is the case on a CAN bus. Packets are authenticated and routed to their appropriate recipient and to no other. Attempts to disrupt the ViNet are stopped by a firewall. Traffic on CAN bus 111 not intended for either CAN node 180 or 190 are filtered out. Frames which may be malformed or follow a different standard may be transformed to a desired standard.

In this embodiment, legacy and conventional CAN-compatible modules may be attached without substantial modification.

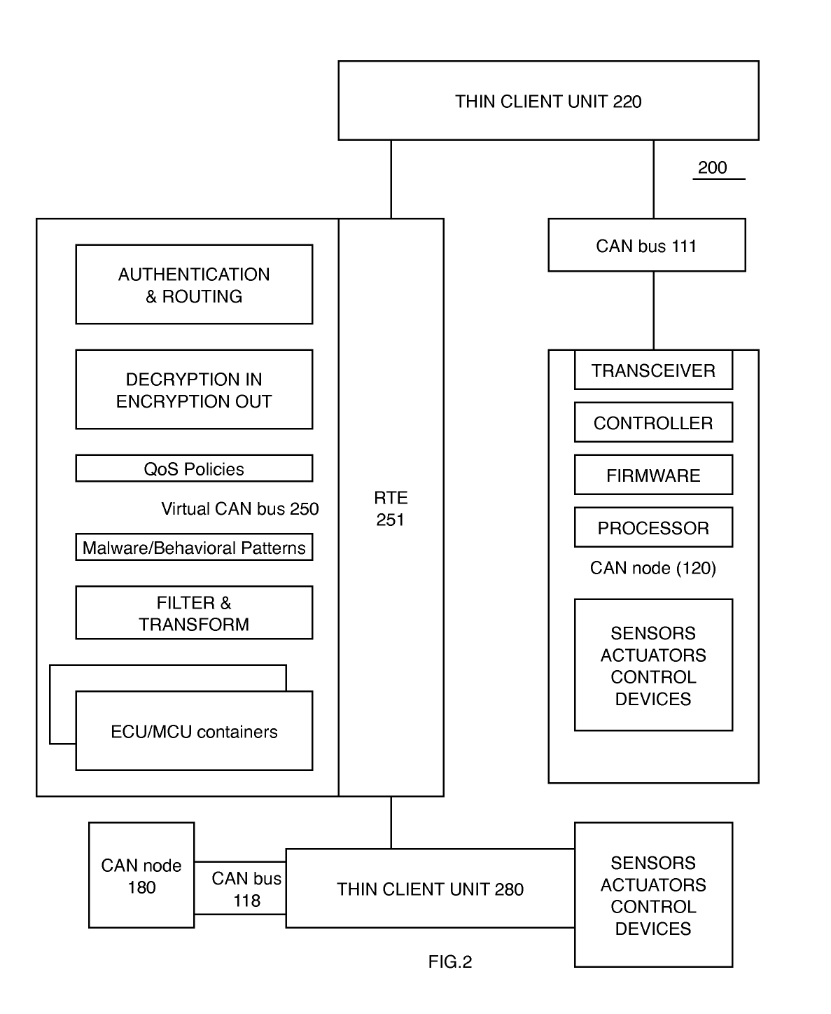

Referring now to FIG. 2 the architecture of the ViNet architecture is illustrated. As before CAN node 120 is coupled to CAN bus 111 and CAN node 180 is coupled to CAN bus 118. Each of the CAN buses are attached to a Thin Client Unit 220, 280 which are interconnected by a Virtual CAN bus 250. The Virtual CAN bus is provided by a real time Ethernet 251 in combination with a ViNet Control Unit (VCU). Packets from each Thin Client Unit are encrypted and transmitted in a virtual channel of the RTE to the VCU. Each packet is authenticated as coming from a legitimate TCU and routed to its destination TCU. All traffic on the RTE is encrypted and passed through the VCU for Malware or Behavioral Pattern Checking and Filtering or Transformation. For example Big Endean to Little Endean incompatibility between two TCU is corrected in the VCU. Quality of Service policies may affect which packets have greater priority to being forwarded.

Providing a substantial additional capability are a plurality of containers provided in the VCU to perform the functions of electronic control units or microcontroller units. This include operating one version while patching, upgrading, or installing another version of the microcode. This supports the attachment of sensors actuators, and control devices directly to a TCU such as 280. Each TCU provides protocol conversion, encryption and decryption, authentication of itself, fault control, and isolation of its attached peripherals from traffic on the RTE. Each TCU enjoys a virtual dedicated channel to the VCU. Each TCU has a personality to constrain its role and prevent incongruous frames from its peripherals from intruding into the ViNet. Each TCU will not accept any packets from the RTE which have not been signed by the VCU.

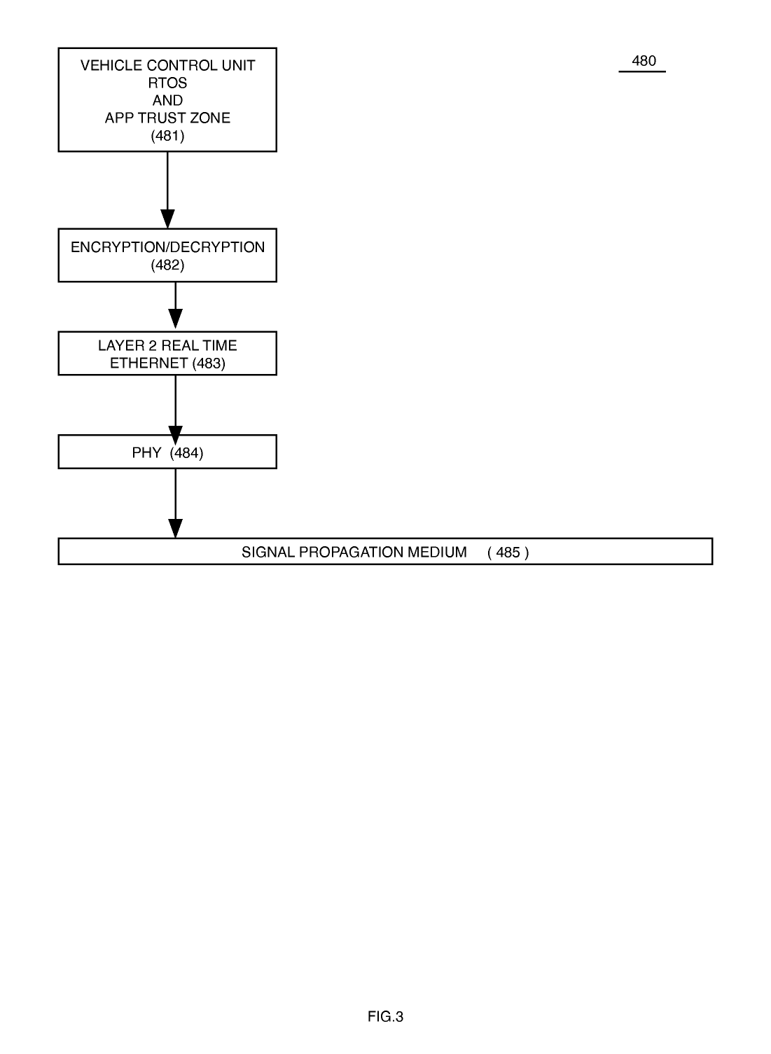

To address the congestion and security challenges of conventional CANbus technology, the present invention provides a secure real time Ethernet channel. Referring now to FIG. 3, an exemplary secure vehicle control network 480 includes a medium 485; the medium coupled to, a PHY circuit 484; the PHY circuit coupled to, a layer 2 real time Ethernet circuit controller 483; coupled to an encryption/decryption circuit (coder) 482; and, the coder coupled to, a vehicle control unit 481 comprising a processor performing a real time operating system and trust zone layer.

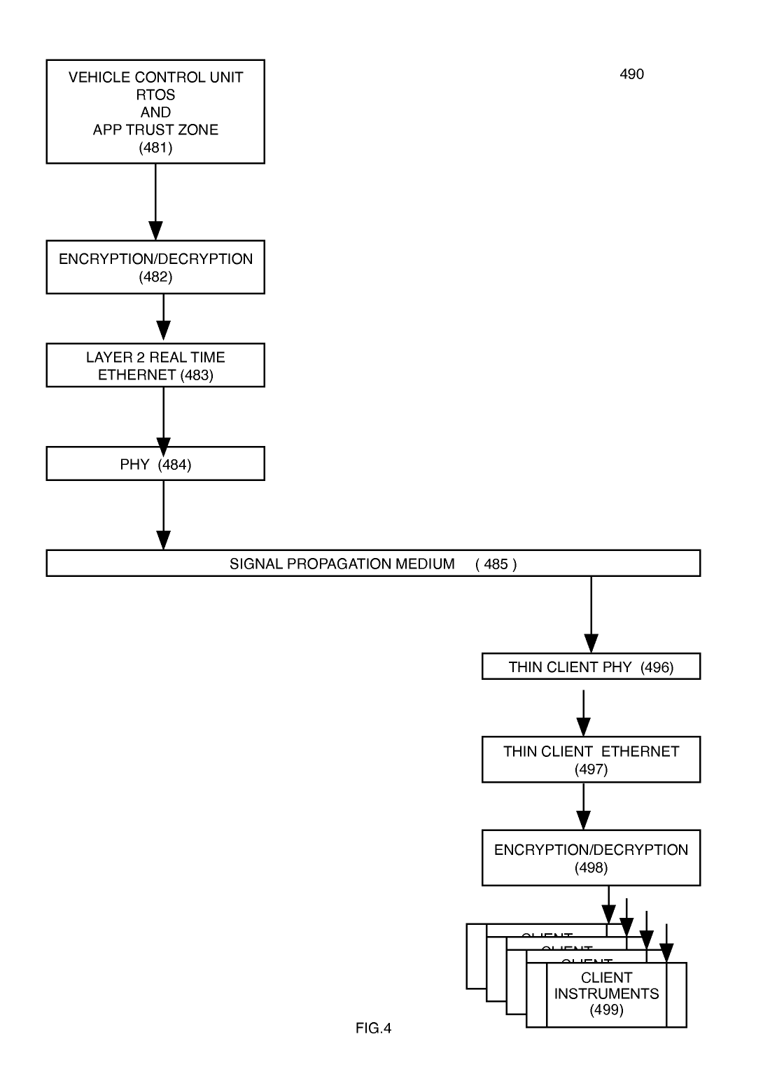

Referring now to FIG. 4, the secure vehicle control network 490 also includes a thin client PHY circuit 496; the PHY coupled to the twisted pair and to, a thin client Ethernet remote node 497; and, an encryption/decryption circuit (coder) 498, for connection to at least one client instrument 499.

An operating system provides an encrypted application programming interface to operate functions such as torque vectoring, cooling, braking, and battery management. In embodiments, the system also includes Electronic ABS circuit; Stability Control circuit; Brake force distribution; and a Regenerative braking circuit.

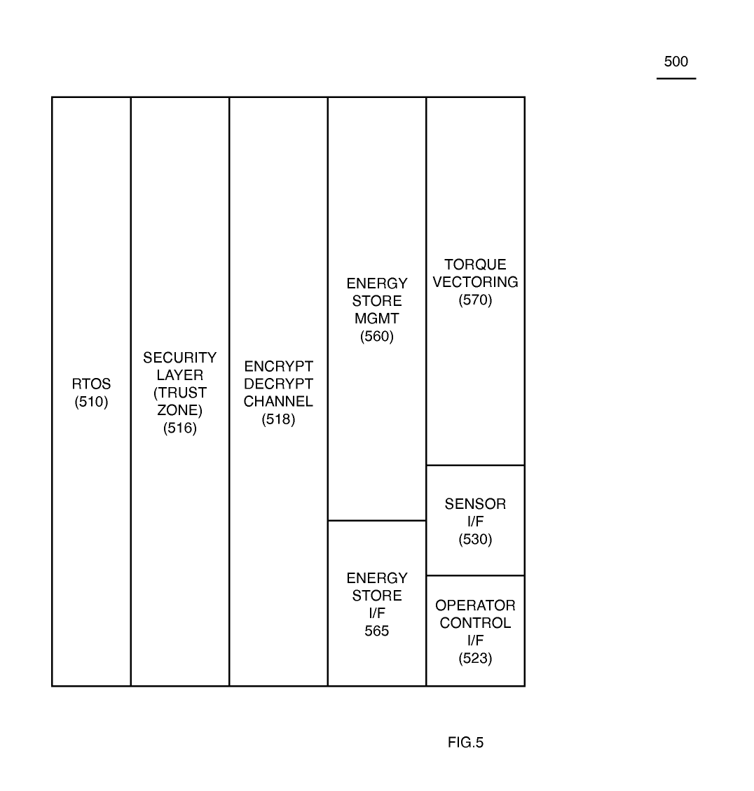

The OS provides an isolating trust zone to each layer or application for authentication and validation. Referring now to FIG. 5, a modular vehicle control unit 500 includes a processor coupled to a non-transitory instruction store, which performs a real time operating system (RTOS) 510; a security layer to provide at least one trust zone 516; an encryption/decryption channel to transmit and receive data and controls over a secure vehicle control network; an energy store management module 560; an energy store interface 565; an operator control interface 523; a sensor interface 530; and a torque vectoring module 570.

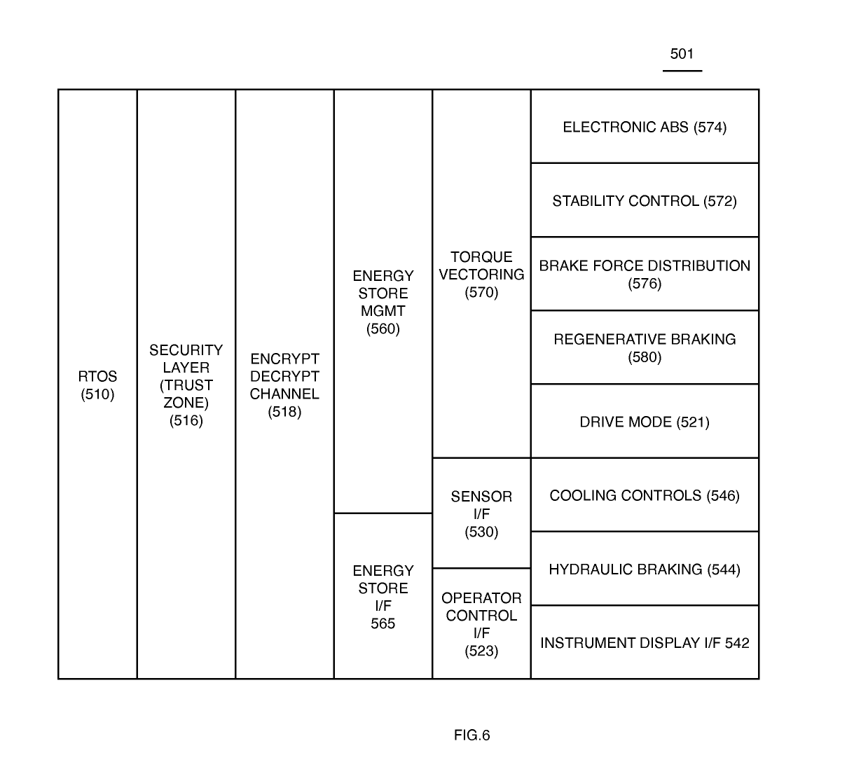

With the new modularity, upgrades are available to install new features or improvements asynchronously from a vehicle product cycle. Referring now to FIG. 6, the modular vehicle control unit also includes 580 Regenerative braking—all 4 wheels for regen braking; 576 Brake Force Distribution—Electronic Stability Control in some circles; 574 Electronic ABS—this is the ABS logic for braking that uses the electric motors; 572 Stability Control—to dampen oscillations due to driver overcorrection; 546 Cooling Controls Interface—maybe better called “Cooling Interface”—connections to the battery, inverters, and other systems; 544 Hydraulic Braking Interface—interface to the hydraulic braking system for monitoring and knowing when its engaged; Instrument Display Interface 542—outputs to the Infotainment display system, covers all systems; Drive Mode Inputs 521—Settings from the driver on the style of driving and settings; wherein the Sensor Interface receives measured Motion, Accelerometers, and wheel spin sensor inputs.

In an embodiment, the system also includes Drive Mode circuit set within the operator control; Cooling control circuits 460; Hydraulic braking circuit 440; and an Instrument display interface 420.

Thus, independent developers may test and furnish new capabilities without exposing or corrupting the IP of other vehicle modalities.

In an embodiment, the indicia received from the at least one sensor is a measure of at least one of acceleration, wheel spin, road traction, and skidding.

In an embodiment, the indicia received from the operator control interface is a measure of at least one of desired vehicle direction, desired vehicle acceleration, desired vehicle speed, and mode of vehicle behavior.

In an embodiment, the VCU receives indicia from the energy store and from the operator control interface to determine an optimal energy efficiency for each inverter.

In an embodiment, the system also includes: Electronic ABS circuit; Stability Control circuit; Brake force distribution; and a Regenerative braking circuit.

In an embodiment the system also includes: Drive Mode circuit; Cooling control circuits; Hydraulic braking circuit; and an Instrument display interface.

Another aspect of the invention is a secure vehicle control network which includes a medium; the medium coupled to, a PHY circuit; the PHY circuit coupled to, a layer 2 real time Ethernet circuit controller; coupled to an encryption/decryption circuit (coder); and, the coder coupled to, a vehicle control unit that includes a processor performing a real time operating system and trust zone layer.

In an embodiment, the secure vehicle control network also has a thin client PHY circuit; the PHY coupled to the twisted pair and to a thin client Ethernet remote node; and, to an encryption/decryption circuit (coder), for connection to at least one client instrument.

Another aspect of the invention is a modular vehicle control unit which includes a processor coupled to a non-transitory instruction store, which performs a real time operating system (RTOS); a security layer to provide at least one trust zone; an encryption/decryption channel to transmit and receive data and controls over a secure vehicle control network; an energy store management module; an energy store interface; an operator control interface; a sensor interface; and a torque vectoring module.

In an embodiment, the modular vehicle control unit also includes Hydraulic Braking Interface—interface to the hydraulic braking system for monitoring and knowing when its engaged.

In an embodiment, the modular vehicle control unit also includes Instrument Display Interface—outputs to the Infotainment display system, covers all systems.

In an embodiment, the modular vehicle control unit also includes Drive Mode Inputs—Settings from the driver on the style of driving and settings.

In an embodiment, the Sensor Interface receives measured Motion, Accelerometers, and wheel spin sensor inputs.

One aspect of the invention is a networking apparatus for interconnection among subsystem modules of a vehicle, which apparatus has a plurality of thin client units (TCU) communicatively coupled to vehicle sensors, actuators, and control devices; at least one virtualized container host (host); and, a real time Ethernet medium coupling the thin client units and the host.

In an embodiment, the thin client unit has a CAN protocol transceiver coupled to a local CAN bus.

In an embodiment, the thin client unit is coupled directly to vehicle sensors, actuators, and control devices without intervening CAN controller and processor.

In an embodiment, each TCU and VCU includes a personality and an encryption/decryption circuit whereby all packets exchanged between a TCU and a VCU are encrypted and authenticated for the recipient.

In an embodiment, each TCU and VCU includes a circuit to transmit and receive packets on the real time Ethernet medium according to their respective personalities.

In an embodiment, each TCU has a circuit to detect and suppress intrusion messages which are inconsistent with its personality.

In an embodiment, each TCU has a circuit to correct and reformat frames from one standard to a desired standard.

In an embodiment, each TCU has a circuit to isolate a malfunction of its local devices.

In an embodiment, each VCU has a circuit to receive all packets from TCUs and retransmit only to an appropriate TCU through a virtual channel.

In an embodiment, the VCU has a plurality of containers to perform a desired functionality of an electronic control unit of a vehicle subsystem.

Another aspect of the invention is a method of operation at a thin client unit including the processes: encoding and decoding real time Ethernet packets; authenticating messages to and from the host; filtering messages and data from attached devices; notifying the VCU of errors, failures, or attacks; transforming between formats or versions of standards; isolating devices from congestion on the vehicle intra network; supporting devices directly or via a CAN protocol bus; and verifying and validating traffic according to its personality.

Another aspect of the invention is a method of operation at a virtualized container host having the processes: performing a series of executable commands of a first version of an electronic control unit in a first container while simultaneously receiving, validating, and installing a second version of the electronic control unit in a second container; receiving packets from a plurality of thin client units, decrypting, authenticating, and validating their payloads and reencrypting and transmitted the packets to only the allowed recipient TCU; ensuring quality of service for timely delivery of packets; detecting an intrusion attack and isolating the attack vector; detecting a malfunction and filtering or suppressing erroneous messages; preventing a TCU from spoofing or attacking another TCU; transforming or translating packets between formats; and providing a single repository for upgrades, corrections, and verification of electronic control unit firmware.

Another aspect of the invention is a secure vehicle control network (SVCN) having: a medium; the medium coupled to, a PHY circuit; the PHY circuit coupled to, a layer 2 real time Ethernet circuit controller; coupled to an encryption/decryption circuit (coder); and, the coder coupled to, a vehicle control unit comprising a processor performing a real time operating system and trust zone layer.

In an embodiment, the secure vehicle control network also has a thin client PHY circuit; the PHY coupled to the medium and to, a thin client Ethernet remote node; and, an encryption/decryption circuit (coder), for connection to at least one client instrument.

### CONCLUSION

The invention can be easily distinguished from conventional vehicle networks and control subsystem which depend on multiple embedded controllers.

The invention can be easily distinguished from conventional vehicle networks and control subsystem which utilize broadcast packets on CANbus to all embedded controllers.

The invention can be easily distinguished from conventional vehicle networks and control subsystems which have unencrypted channels vulnerable to intrusion attack.

The invention can be easily distinguished from conventional vehicle networks and control subsystem which require stabilization of all subsystems into a customized configuration for production release and cannot be practically updated between car cycles (2 years).

The invention can be easily distinguished from conventional vehicle networks and control subsystem which suffer congestion and latency problems as more intelligence is expected in future vehicle designs.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A networking apparatus for interconnection among subsystem modules of a vehicle, wherein apparatus comprises:
a plurality of thin client units (TCU) communicatively coupled to vehicle sensors, actuators, and control devices;
at least one virtualized container host (host); and,
a real time Ethernet medium coupling the thin client units and the host.

2. The apparatus of claim 1 wherein the thin client unit comprises a CAN protocol transceiver coupled to a local CAN bus.

3. The apparatus of claim 1 wherein the thin client unit is coupled directly to vehicle sensors, actuators, and control devices without intervening CAN controller and processor.

4. The apparatus of claim 1 wherein each TCU and VCU comprise a personality and an encryption/decryption circuit whereby all packets exchanged between a TCU and a VCU are encrypted and authenticated for the recipient.

5. The apparatus of claim 1 wherein each TCU and VCU comprise a circuit to transmit and receive packets on the real time Ethernet medium according to their respective personalities.

6. The TCU of claim 1 comprises a circuit to detect and suppress intrusion messages which are inconsistent with its personality.

7. The TCU of claim 1 comprises a circuit to correct and reformat frames from one standard to a desired standard.

8. The TCU of claim 1 comprises a circuit to isolate a malfunction of its local devices.

9. The VCU of claim 1 comprises a circuit to receive all packets from TCUs and retransmit only to an appropriate TCU through a virtual channel.

10. The VCU of claim 1 comprising a plurality of containers to perform a desired functionality of an electronic control unit of a vehicle subsystem.

11. A method of operation at a thin client unit comprising:
encoding and decoding real time Ethernet packets;
authenticating messages to and from the host;
filtering messages and data from attached devices;
notifying the VCU of errors, failures, or attacks;
transforming between formats or versions of standards;
isolating devices from congestion on the vehicle intra network;
supporting devices directly or via a CAN protocol bus; and
verifying and validating traffic according to its personality.

12. A method of operation at a virtualized container host comprising:
performing a series of executable commands of a first version of an electronic control unit in a first container while simultaneously receiving, validating, and installing a second version of the electronic control unit in a second container;
receiving packets from a plurality of thin client units, decrypting, authenticating, and validating their payloads and reencrypting and transmitted the packets to only the allowed recipient TCU;
ensuring quality of service for timely delivery of packets;
detecting an intrusion attack and isolating the attack vector;
detecting a malfunction and filtering or suppressing erroneous messages;
preventing a TCU from spoofing or attacking another TCU;
transforming or translating packets between formats; and
providing a single repository for upgrades, corrections, and verification of electronic control unit firmware.

13. A secure vehicle control network (SVCN) comprising:
a signal carrying medium; the medium coupled to,
a PHY circuit; the PHY circuit coupled to,
a layer 2 real time Ethernet circuit controller; coupled to
an encryption/decryption circuit (coder); and, the coder coupled to,
a vehicle control unit comprising a processor performing a real time operating system and trust zone layer.

14. The secure vehicle control network of claim 13 further comprising:
a thin client PHY circuit; the PHY coupled to the medium and to,
a thin client Ethernet remote node; and,
an encryption/decryption circuit (coder), for connection to at least one client instrument.
